(19) United States
(12) Patent Application Publication
(10) Pub. No.: US 2013/0146107 A1
(43) Pub. Date: Jun. 13, 2013

(54) EQUIPMENT FOR TREATING CONTAINERS OF CHEMICAL PRODUCT

(71) Applicant: Antonio Prado Castro, Estepona (Malaga) (ES)

(72) Inventor: Antonio Prado Castro, Estepona (Malaga) (ES)

(21) Appl. No.: 13/583,286

(22) PCT Filed: Mar. 2, 2011
(86) PCT No.: PCT/ES11/70135

§ 371 Date: Jan. 29, 2013

(30) Foreign Application Priority Data
Mar. 8, 2010 (ES) P20100272

(51) Int. Cl. B08B 3/10

(52) U.S. Cl. CPC B08B 3/10
USPC 134/109

(57) ABSTRACT

The equipment is based on the use of active-carbon filters (5) for the absorption of halogens originating from the cleaning of containers of chemical product, which includes a chassis (1) that supports a stainless-steel tank (3), which contains the containers to be treated or cleaned, and also conduits (9) that finish off as flexible nozzles (10) via which water is propelled towards the inside of the containers, the bottom of said tank (3) having a manual purge device (14), positioned in a well (13). The equipment comprises boost (15) and sorption (16) pumps, for the cleaning liquid and for dissolution towards the active-carbon filters, respectively, and also rigid and flexible connections (17) corresponding to the hydraulic circuit for distribution of the liquid and dissolution. The chassis (1) has wheels (2) so that it can be moved from place to place.

### OBJECT OF THE INVENTION

The present invention relates to equipment for treating containers of chemical product, based on the utilization of activated carbon filter as absorbent.

The object of the invention is to purge the halogenated compound, leaving the corresponding containers clean for handling as plastic material, obtaining clean water reutilizable for multiple purposes.

### BACKGROUND OF THE INVENTION

The cleaning of waste water of biocides and organic chemical products present in given types of container, such as those utilized in the fruit and vegetable sector, may be realized in multiple ways, and in this respect the patent ES 2208266 may be cited wherein there is described equipment for cleaning waste water from fruit and vegetable packing plants and in situ phytosanitary treatments utilizing activated carbon filtering, the waste water being previously clarified by making it pass through a decanter tank to which may be added flocculant, and wherein the mud is collected in a filter bag, such that the clarified water is stirred to obtain homogeneous clarified water prior to the passage thereof through the activated carbon filters.

Similarly British patent GB 2273521 may be cited, wherein there is described a filter to eliminate pesticides from water based on the utilization of sand and activated carbon.

In patent ES 1022144 there is described a machine for cleaning plastic containers destined for the storage of fruit and vegetable or other products, wherein the containers to be cleaned pass through a tank of hot water at the outlet whereof there is provided a rotary brush which cleans the lower part of the containers, there being subsequently located a conveyor belt which picks up the containers proceeding from the tank of hot water, passing them through a cubicle wherein there are provided at the entry thereto flexible sheets or flaps, and in the interior whereof there is provided a bridge piece having nozzles projecting water under pressure for the final cleaning and rinsing of the containers.

In Spanish Utility Model U 1050822 there is described another washing machine for containers, cleaning being carried out by the projection of hot water through spray nozzles.

In patent DE 4234062 there is described an apparatus for the disinfection and cleaning of waste containers, wherein it is stated that there is a filter which may be made of activated carbon and a mechanism for transporting and sealing the containers, based on the application of steam to said containers.

A further apparatus for cleaning containers is also described in patent GB 2301022, wherein there is a tank of water and a washing apparatus in which the dirty containers are positioned for the cleaning thereof by spraying and brushing the interior of the containers with water, the apparatus having multiple filters and water manifolds to collect the filtered washing water and a pump to transport the water from the manifold to the storage vessel.

In patent DE 4129732 there is described a yet further apparatus for cleaning waste water based on a water container, a pump, a propulsion system and a carbonization chamber, wherein there is provided a filter containing a layer of activated carbon such that an endless screw disposed on the axis of the carbonization chamber draws the material to the upper part wherein the filter is located, this apparatus being utilized for cleaning urban and industrial waste water.

Finally, patent CN 201049917 describes an installation for cleansing waste water of pesticides, wherein there is a water inlet, a storage tank, a force pump, an activated carbon filter and a microfiltration or ultrafiltration apparatus.

The majority of the aforementioned apparatuses or machines are of large volume and are static, that is to say that they cannot be moved from place to place to be capable of being utilized in accordance with the requirements in the desired location.

Moreover, the majority of said equipment or apparatuses are provided for cleaning boxes or containers and although in some cases they effect the management of waste water, they do not carry out the simultaneous function of treating containers and cleaning water of biocides and organic chemical products with the objective of obtaining clean water reutilizable for multiple purposes.

### DESCRIPTION OF THE INVENTION

The equipment advocated, provided for the treatment and/or cleaning of containers of chemical products, has as the scientific basis thereof the absorption of halogenated compounds by activated carbon, specifically by activated carbon filters, achieving cleaning out the halogenated compound to leave the containers clean for the handling thereof as plastic material.

More particularly, the equipment of the invention is constituted based on a chassis of stainless steel tubing, having wheels for the displacement thereof from place to place without any kind of problem, two thereof being fixed and the remaining two being orientable, on the chassis whereof there is mounted a tank wherein cleaning of the containers takes place, which tank includes a cover having a special hermetic seal and in the interior thereof a support for the containers, a support for the caps, together with tubes having flexible extremity sections and nozzles projecting the water for the cleaning and washing of said containers, and a water level float.

Moreover, there is provided in said tank, in specific correspondence with the bottom thereof, a non-return suction filter and a manual draining device.

Laterally and externally to the tank are provided activated carbon filters whereinto enters the water proceeding from the aforementioned tank.

In addition to acting as support for the aforementioned activated carbon filters, the lower part of the chassis constitutes a support for a force pump forcing the water through the nozzles in order to clean the containers located within the tank, and a suction pump by means whereof the water is made to pass along the corresponding channeling through the activated carbon filters, there being appropriate, preferably flexible, connection conduits and corresponding connections, all thereof in combination with software for programming the functioning of the equipment, supported on the corresponding electronic control circuit.

The equipment described is equally applicable to the elimination of the organic compound formaldehyde present in given substances of hospital use and requiring management of the waste by authorized companies, such that by means of the equipment of the invention it is possible to realize the retention of this organic compound and other chemical substances, such as ethanol, phenol and formol, permitting the direct elimination thereof via the drainage system, with the consequent practical and economic solution in respect of the cost of handling and removal by authorized companies of the quantities of said organic compound generated in hospital establishments, principally in research sections, although naturally also in hospital treatment sections.

It is clear that the organic residue of these substances is retained on the specific carbon filters which subsequently, in accordance with the volumes managed, will be removed by maintenance personnel and replaced by new filters.

The equipment furthermore permits effecting the washing of equipment for applying biocides/pesticides which, having realized such work, are contaminated by said biocide utilized and which, in accordance with health legislation, require to be washed by a triple rinse system, such an operation being currently impossible without contravening the existing regulations in relation to chemical waste. This benefit of the machine is specific to pest control companies, both urban and crop treatment.

### DESCRIPTION OF THE DRAWINGS

For the purpose of supplementing the description given below and with the object of assisting the better comprehension of the characteristics of the invention in accordance with a preferred practical example of the embodiment thereof, there is included as an integral part of said description a set of drawings wherein, being of an illustrative and non-limitative nature, the following is depicted:

FIG. 1 shows a schematic depiction corresponding to a general perspective view of the equipment that it is the subject of the invention.

FIG. 2 shows a lateral perspective depiction of the same equipment depicted in the aforementioned figure, with the corresponding activated carbon filters revealed.

FIG. 3 shows a detail in lateral perspective of the lower part of the equipment wherein there may be clearly observed the chassis, wheels, pumps and hydraulic connections.

Lastly, FIG. 4 shows an upper perspective view of the tank comprised in the equipment of the invention, permitting the internal components of said tank to be observed.

### PREFERENTIAL EMBODIMENT OF THE INVENTION

As may be observed in the aforementioned figures, the equipment of the invention is constituted based on a chassis (1), preferably made of tubular steel, to achieve the utmost minimization of the weight thereof, being made of stainless steel to inhibit possible causes of corrosion through humidity or liquid spill, which chassis (1) incorporates wheels (2) underneath for the transfer or displacement thereof from place to place, rendering said equipment mobile for the utilization thereof in the desired place.

Upon said chassis (1) there is supported a tank (3), also made of stainless steel specifically to resist continuous contact with chemical substances, with the corresponding cover (4) thereof having special sealing means of the wing nut type with height adjustment.

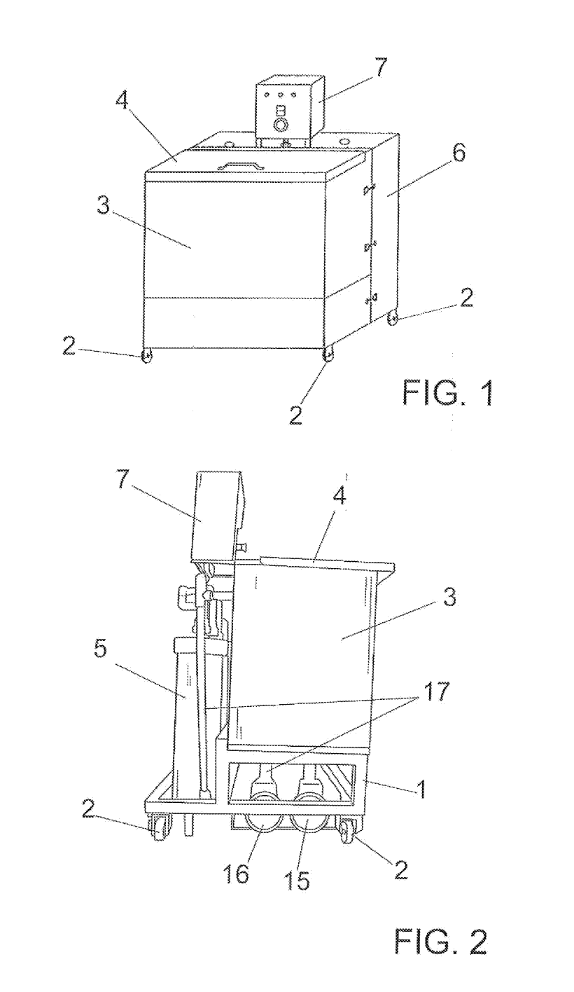

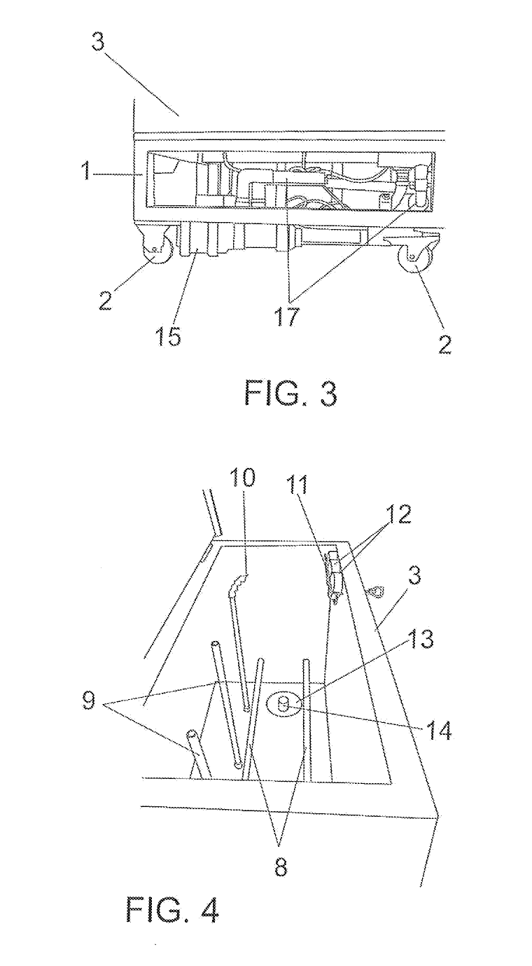

On the same chassis (1) there are also provided activated carbon filters (5), supported at a level lower than that of the tank (3) and situated collaterally thereto, which may be protected by a housing (6) as may be observed in FIG. 1. Said filters dispose of a pressure gauge to indicate the pressure and monitor the saturation by retained residues.

Upon the upper part there is provided the corresponding electric panel cabinet (7), with front cover, indicator lights, control switches and, interiorly, the corresponding connections, including circuit breaker, residual current device, etc., although it is possible to displace said control panel towards the side at the rear situating it, separately, at one side of the three filters with the control switches on this side without this affecting the essence of the invention. This control panel permits activation of the operation of 1, 2 or 3 of the washing nozzles present. It is possible to realize the function of the nozzles with the cover open to permit the washing of biocide application equipment.

In the case of application equipment of large volume the washing is realized by hose in the application tank itself, the resulting waste water being evacuated to the tank of the equipment of the invention for the filtration thereof.

In the interior of the tank (3) there are provided stainless steel horizontal bars (8) in proximity to the bottom as means of support for the corresponding containers to be cleaned or treated, together with vertical tubes or conduits (9) in the upper extremity whereof are incorporated flexible nozzles (10) to force water towards the containers disposed on the supports constituted by the horizontal bars (8), there moreover being in the interior of said tank (3) an internal lateral support (11) for caps (12), as may be clearly observed in FIG. 4, and in the bottom a suction well (13) with a manual draining device (14), including furthermore an undepicted level float.

The cleaning water projected through the flexible nozzles (10) in the interior of the tank (3) is driven by a pump (15), whilst the solution produced in the cleaning reaches the activated carbon filters (5) by means of a suction pump (16), the cleaning water exiting the latter for collection and subsequent reutilization thereof for any appropriate use.

The hydraulic connections between the pumps, tank and activated carbon filter are connections (17) having a rigid part in order to be resistant to the chemical product and to allow disassembly at strategic points for maintenance work, furthermore having flexible parts to facilitate such maintenance and, naturally, to facilitate making the corresponding connections.

Furthermore, there is provided a brass manifold having corresponding outlets for cleaning the containers in the interior of the tank (3).

In the operational form of the equipment, the containers are previously disposed situated with the mouths thereof down, that is to say on the support bars (8) provided in proximity to the bottom of said tank (3), the flexible water projecting nozzle (10) being situated within the container itself such that, having closed the corresponding cover (4) of the tank (3), a microswitch is actuated that is connected to the corresponding pushbutton on the electrical panel or cabinet, and the process is initiated of cleaning the containers of chemical product with the intervention of a programmer and specific software, which may be regulated to lengthen or shorten the operating cycle.

In operation, the force pump (15) actuates during the period programmed such that, in combination with the corresponding level float provided within the interior of the tank (3), when the latter is actuated during a minimum period of time, a signal is sent to the suction pump (16) to start functioning and commence passing water along the channeling through the activated carbon filters (5), and such that for safety and to prevent the suction pump (16) working empty, the system is calibrated in order that a water level of 2 cm remains in the tank (3), which water will not contain chemical product and may always be emptied by the manual draining device (14) provided in the bottom.

The equipment may work in two different manners, one as an open system, wherein the inlet water originates directly from the grid and is expelled to the activated carbon filters (5) and may be stored or not, whilst the second manner of working is as a closed system, wherein the inlet water originates from a tank and at the outlet from the activated carbon filters (5) it again returns to said tank.

In the case of an open system, greater pressure can be achieved by virtue of the fact that to the working pressure of the force pump there is added the pressure from the water company, although the result of cleaning the containers will entail high water consumption, whilst in the closed system the pressure and volume are reduced, but a practically nil consumption of water is, however, achieved.

Finally, it is emphasized that the equipment has a casing or sheathing enveloping the entirety of the structure, being neatly closed with the sealing cover.

1. Equipment for treating containers of chemical product based on the principle of absorption of halogens by activated carbon filters, wherein it is constituted based on a chassis having wheels for the displacement thereof, a tank with sealing cover being provided to house in the interior thereof the containers to be treated, including laterally and externally to the tank activated carbon filters wherethrough passes the solution generated in the cleaning of the containers within the interior of the tank, being supplemented by a hydraulic system based on force and suction pumps, to force the water from the interior of the tank through flexible nozzles, and for the suction of the solution generated towards the activated carbon filters, the latter being mounted externally and laterally to the tank and in a low position on said chassis.

2. The equipment for treating containers of chemical product, as claimed in claim 1, wherein it includes rigid and flexible connections for connection between the force and suction pumps and the tank and activated carbon filters.

3. The equipment for treating containers of chemical product, as claimed in claim 1, wherein within the interior of the tank there are provided horizontal bars in proximity to the bottom as support for the containers to be cleaned and purged, together with vertical conduits terminating in the corresponding flexible nozzles for the disposition thereof within the interior of the containers situated with the mouths thereof down, supported on the bars, there being provided in the bottom a suction well, a manual draining device, in addition to a support for caps provided laterally in proximity to the upper part of the tank.

4. The equipment for treating containers of chemical product, as claimed in claim 1, wherein both the chassis and the tank, support bars, conduits and, naturally, the cover of the tank are made of stainless steel.

5. The equipment for treating containers of chemical product, as claimed in claim 1, wherein it includes an electric control cabinet or panel in combination with a programmer establishing the cyclic operation of said equipment.
